(19) United States
(12) Patent Application Publication
(10) Pub. No.: US 2007/0245837 A1
(43) Pub. Date: Oct. 25, 2007

(54) STRAIN MEASURING DEVICE

(75) Inventors: Jon SCOTT, Greenville, SC (US); Tom LEAHY, Villefranche du Perigord (FR); Philip MARIANI, Lyman, SC (US)

Correspondence Address: STANDLEY LAW GROUP LLP, 495 METRO PLACE SOUTH, SUITE 210, DUBLIN, OH, 43017, US

(73) Assignee: Mettler-Toledo, Inc., Columbus, OH (US)

(21) Appl. No.: 11/379,402

(22) Filed: Apr. 20, 2006

(51) Int. Cl. G01L 1/22

(52) U.S. Cl. 73/862.627

(57) ABSTRACT

A tensile force measuring device provides improved linearity and temperature transient behavior. A column load cell (10) in the device is connected at its ends to a first and a second roller chain portion (34, 36), which are in turn connected to the tensile force, to dispose the column load cell to the tensile force between the chain portions. The roller chain portions are connected to the load cell in mutually perpendicular orientation. The load cell has notches (18) formed in the side thereof to equalize the strain thereupon when tensile load is applied. Longitudinal and transverse strain gages (20) are positioned longitudinally intermediate to the notches, and may be on a gaging web (22).

### TECHNICAL FIELD

The present invention relates to strain measuring devices and more particularly to a load cell that provides improved linearity and temperature transient behavior. More particularly, the invention relates to a strain measuring device having a column load cell positioned between a pair of perpendicularly-oriented roller chain portions

### BACKGROUND OF THE ART

Tensile and compressive forces today are measured with a wide variety of technologies. Most of the lowest cost designs use strain gages and many designs exist. One of the oldest and most popular strain gage designs is the column load cell. Columns usually have a long, slender elastic member loaded along its long axis in either tension or compression. Strain gages are affixed to the elastic member in such a way that both the longitudinal and transverse strains can be measured and combined to produce a total output proportional to the load. These devices usually assume that strain gages perfectly measure strain and that strain is proportional to load, so the output is assumed to be directly proportional to load.

Unfortunately, if the output of a real column cell is plotted against load, the plotted curve is not straight (nonlinear). The value of the nonlinearity is often observed to be 500-1000 ppm.

Most users of column load cells want an output curve having a nonlinearity which is less than 300 ppm and many even want it less than 50 ppm. To achieve this level of straightness in the output curve, a variety of methods are used. One method is to change the Wheatstone bridge excitation voltage as a function of load. This method often relies on a semiconductor strain gage mounted on the load cell, whose resistance changes greatly with strain and is used to change the excitation voltage. The semiconductor strain gages introduce almost as many problems as they solve, however. They are expensive, difficult to handle during manufacture and prone to large resistance changes with temperature.

Another method is to build a computer into the load cell. The computer's software can be used to straighten the output curve, plus provide correction for other cell errors. The computer method is widely regarded as being the most accurate and routinely produces cells having errors less than 50 ppm. Short of using a computer, methods have also been tried using active circuits (operational amplifiers) to obtain linearity correction. However, both computers and active circuits restrict the user in terms of either the power requirements, signal outputs, or both.

It is commonly believed that the change in dimensions of a column cell's elastic member is responsible for its nonlinear output curve. For example, if a column cell with a circular cross section is loaded in compression, the diameter at zero load is smaller than its diameter with any load applied. A greater diameter implies a stiffer elastic member and less deflection for the same load increment. Additional increments of load cause corresponding smaller strains, so that a load increment at full capacity of the load cell should cause less output than the same increment applied at zero load.

Another common explanation for a column's nonlinear output concerns the way the tensile and compressive strains are combined to form the total output signal. A Wheatstone bridge is often used to combine the longitudinal strains (compressive, for a cell in compression) and transverse strains (tensile, for a cell in compression). A Wheatstone bridge is used because it is inexpensive and can compensate for many scenarios in which some strain gages might be at different temperatures from other gages, as well as compensating for other problems. However, if the tensile and compressive strains are unequal in absolute value, then the Wheatstone bridge will give an output which is nonlinear even if the strains themselves are perfectly linear. This effect is well known and published by strain gage manufacturers in their product data.

Mathematical modeling of the diameter change and the Wheatstone bridge nonlinearities is unable to predict a total cell output which matches experimental measurements. These effects are simple and easy to quantify, yet they do not explain the nonlinear output of real load cells. For example, the bridge nonlinearity for a typical cell might be about 200 ppm, while the change in diameter causes a nonlinearity of about +180 ppm. These nonlinearities add to cause a predicted nonlinearity of about 20 ppm, but the actual load cell displays nonlinearities of +500 to +1000 ppm, with +800 ppm being a typical value. Otherwise identical manufacturing methods routinely produce cells having a variation in linearity in the aforementioned +500 to +1000 ppm range, but such a large change variation is also unexplained using the diameter change and Wheatstone bridge nonlinearities. This suggests that other sources of nonlinearity must exist in real column load cells, in addition to the ones commonly mentioned.

Further work on mathematical modeling suggests that the strain gage itself is nonlinear. It can easily be shown that strain gages are nonlinear and the nonlinearity is dependent on many factors, some that are well understood and some that are not. Several strain gage manufacturers sell gages which exhibit very different linearity and hysteresis performances when installed on the same load cell. Therefore, it is clear that the strain gages themselves are nonlinear and the degree of nonlinearity varies from batch to batch of gages and from gage type to gage type.

If strain gages are wired into a Wheatstone bridge and the absolute values of their strains are equal, it can be shown that the output of the bridge is almost perfectly linear with strain, whether the gages are linear or nonlinear. This of course assumes the strains themselves are perfectly linear. This relationship holds for most reasonable values of nonlinearity from commercially available strain gages. However, if the absolute values of the strains on the four arms of the bridge are unequal, then the output of the Wheatstone bridge is much more nonlinear. This is the fundamental flaw in commercially available column load cells: the strains they measure in the transverse direction are usually about −0.3 (Poisson's ratio) times the strain in the longitudinal direction. The smaller strain magnitude yields a bridge output which is nonlinear and varies depending on the nonlinearity of the gages used to build it.

An old design called a proving ring measures tension or compression forces. This device is essentially a metal ring with alternating locations of tensile and compressive strain around the ring's circumference. This device has excellent linearity, in that the magnitudes of tensile strain are equal to those of compressive strain.

Unfortunately, this device exhibits such poor behavior in the presence of temperature changes that it isn't practical for commercial load cells. The primary cause of its temperature problems is that the tension and compression gages are usually not close to each other and are often mounted on metals of different thicknesses, so that the temperatures of the tension and compression gages are usually unequal.

Beam load cells are common in the market and have excellent linearity and temperature performance. These devices are designed to be placed in shear (and possibly bending) during loading, and generally have a large dimension transverse to the loading direction. The requirement for shear loading also places significant demands on their mounting: the mounting must be capable of sustaining the moments applied during shear loading. Their size transverse to the loading direction and the mounting requirements often make them an unattractive option compared to column load cells.

### SUMMARY OF THE INVENTION

An advantage of the exemplary embodiment of the present invention is to provide a means for improving the linearity in a column load cell while retaining the column load cell's favorable temperature transient behavior.

This advantage is achieved by a column load cell having a body with an elongate axis and having a connector at each end. The respective end connectors are adapted for connection of a roller chain portion, but the connectors are in mutually perpendicular orientation.

In some embodiments, the elongate body of the load cell has notches formed in the side thereof to equalize the strain thereupon when tensile load is applied.

In many embodiments, the column load cell also comprises at least one longitudinal strain gage and at least one at least one transverse strain gage, with the respective strain gages positioned longitudinally intermediate to the notches.

In some embodiments, the plurality of strain gages are mounted on a gaging web that is positioned longitudinally intermediate to the notches.

Other advantages of the invention may be achieved by a device for measuring the magnitude of a linear tensile force, the device having improved linearity and temperature transient behavior. Such a device would incorporate a column load cell of an embodiment described above, the connectors of which will be connected to an end of a pair of roller chain portions, with the opposite ends of the roller chain portions receiving the tensile force through attachment to a source of the tensile force.

### BRIEF DESCRIPTION OF THE DRAWINGS

The present invention will be better understood when reference is made to the accompanying drawings, in which identical features are identified with identical part numbers and wherein:

FIG. 1 is an elevational view of a column load cell of the present invention; and

FIG. 2 is a perspective view of a device for measuring tensile force, incorporating the column load cell embodiment of FIG. 1.

### DETAILED DESCRIPTION OF AN EXEMPLARY EMBODIMENT

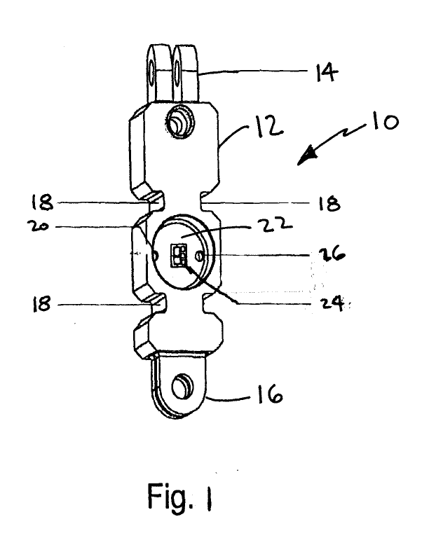

FIG. 1 shows an exemplary embodiment of a load cell 10 of the present invention. The load cell 10 is characterized by an elongate body 12, each end of which is adapted with a connector for receiving a roller chain. The notable feature of the connectors is not that their similarities, but is their difference. The first connector 14 is oriented to receive a roller chain portion in which the parallel pins that connect the links are oriented in a left to right axis across the plane of the drawing. The second connector 16 is oriented to receive a roller chain portion in which the parallel pins that connect the links are oriented in an axis coming normally out of the plane of the drawing. Described in another way, the load cell 10 and the connectors 14,16 at the ends thereof are in mutually orthogonal orientation. The load cell 10 is also characterized by four notches 18 that represent removed material from what would be an otherwise generally rectangular cross-section.

Mounted in a transverse gaging hole 20 through the load cell 10 is thin gaging web 22, on which are mounted a plurality of strain gages, identified collectively by reference numeral 24. These gages 24 are oriented both longitudinally and transversely. Sending an output of these gages to a Wheatstone bridge (not shown) is well known in the art.

In FIG. 1, the depicted embodiment shows two holes 16 through the gaging web 22. These holes enhance the longitudinal and transverse strains experienced by the strain gages 24 both by weakening the web 22 and by funneling the large strains over the narrow area occupied by the gages. While two holes 26 are depicted, it will of course be known in the art to provide even more holes.

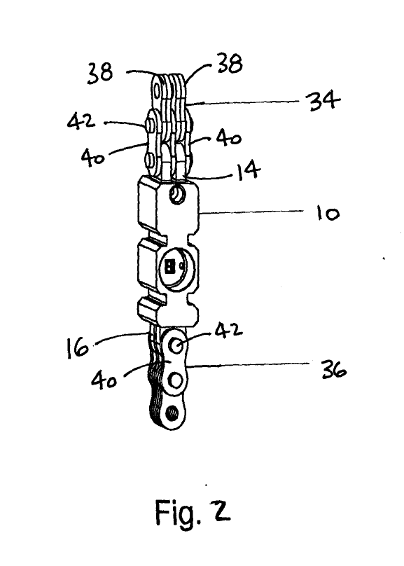

FIG. 2 shows an application of the load cell 10 of FIG. 1 for measuring tensile forces. In this depiction, a portion of a first and a second roller chain 34, 36 is shown, with first roller chain 34 connected at one end to connector 14 and second roller chain 36 connected at one end to connector 16. In a well-known structure, each roller chain portion 34, 36 comprises alternating pairs of inner links 38 and pairs of outer links 40, held together by pins 42. The pins 42, which are in parallel relationship, define a directionality of the roller chain portion. This structure embues the roller chain portions 34, 36 with a flexibility in one radial direction and a great rigidity in the orthogonal radial direction. If the chains 34, 36 were connected to the column load cell 10 in the same orientation, radial forces could cause bending stresses in the load cell 20 and cause an inaccurate weighing result. However, when oriented in the orthogonal manner of FIG. 6, any radial force will be resolvable into a pair of orthogonal components that will be relieved by the respective flexible roller chains and not transmitted into the load cell 10.

A potential use of the present invention is found is association with a weighing device that is used in a forklift truck.

Although the present invention has been described in considerable detail with reference to certain preferred versions thereof, other versions are possible. Therefore, the point and scope of the appended claims should not be limited to the description of the preferred versions contained herein.

What is claimed is:

1. A column load cell, comprising:
a body with an elongate axis and having a connector at each end thereof, the respective connectors adapted for connection of a roller chain portion, the connectors being in mutually perpendicular orientation.

2. The column load cell of claim 1, wherein:
the body has notches formed in the side thereof to equalize the strain thereupon when tensile load is applied.

3. The column load cell of claim 2, further comprising:
at least one longitudinal strain gage; and
at least one at least one transverse strain gage;
the respective strain gages mounted on the body longitudinally intermediate to the notches.

4. The column load cell of claim 2, further comprising:
a gaging web positioned longitudinally intermediate to the notches; and
a plurality of strain gages mounted on the gaging web.

5. A device for measuring the magnitude of a linear tensile force, the device having improved linearity and temperature transient behavior, comprising:
a column load cell of claim 1
a first and a second roller chain portion, the first ends of the roller chain portions connected to the tensile force, and the column load cell disposed between the respective second ends of the chain portions, which are connected to the connectors.

6. The device of claim 5, wherein:
the column load cell has notches formed in the side thereof to equalize the strain thereupon when tensile load is applied.

7. The device of claim 6, further comprising:
at least one longitudinal strain gage; and
at least one at least one transverse strain gage;
the respective strain gages positioned longitudinally intermediate to the notches.

8. The device of claim 6, further comprising:
a gaging web positioned longitudinally intermediate to the notches; and
a plurality of strain gages mounted on the gaging web.
